(19) United States
(12) Patent Application Publication
(10) Pub. No.: US 2019/0193449 A1
(43) Pub. Date: Jun. 27, 2019

(54) PRINTING PLATE

(71) Applicant: FUJIFILM MANUFACTURING U.S.A., INC., Greenwood, SC (US)

(72) Inventors: Darrell Terry, Greenwood, SC (US); Paul Klich, Greenwood, SC (US); Tyler Brewington, Greenwood, SC (US); George Oliver, Greenwood, SC (US)

(21) Appl. No.: 16/232,878

(22) Filed: Dec. 26, 2018

Related U.S. Application Data
(60) Provisional application No. 62/610,837, filed on Dec. 27, 2017.

(51) Int. Cl. B41N 1/08; B41F 7/02

(52) U.S. Cl. CPC B41N 1/083; B41P 2200/21; B41F 7/02

(57) ABSTRACT

A lithography printing plate and method for using the same are disclosed. In one embodiment, the printing plate comprises a metallic plate having top and bottom sides with one or more coating layers on the first side of the metallic plate. A layer is attached to the second side of the metallic plate, thereby forming a laminate.

### PRIORITY

The present patent application claims priority to and incorporates by reference the corresponding provisional patent application Ser. No. 62/610,837, titled, “Printing Plate,” filed on Dec. 27, 2017.

### FIELD OF THE INVENTION

Embodiments of the present invention relate to the field of offset printing; more particularly, embodiments of the present invention relate to printing plates having laminated backsides.

### BACKGROUND OF THE INVENTION

Offset printing is a printing technique used to transfer or offset an image on a plate to a blanket and then to a printing surface. Offset printing is often combined with a lithographic process. In such a case, a printing plate is used as an image carrier that is exposed and processed and thereafter wrapped around a cylinder or roller of a press for printing. The plate contains image areas that accept ink and repel water and non-image areas that accept water.

Today, the majority of lithographic plates are made of aluminum sheets of various thicknesses. The plates are typically plated with one or more coatings with a light sensitive material, thereby making them pre-sensitized. To prepare the printing plate for use, they are exposed to light or heat to produce a plate that is ready for use in an offset printing press.

As the plates are typically made of aluminum, the cost of the plates can be higher than desired. It is desirable to reduce the cost of the plates.

### SUMMARY OF THE INVENTION

A lithography printing plate and method for using the same are disclosed. In one embodiment, the printing plate comprises a metallic plate having top and bottom sides with one or more coating layers on the first side of the metallic plate. A layer is attached to the second side of the metallic plate, thereby forming a laminate.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates an example of a printing plate.

FIG. 2 illustrates another embodiment of a printing plate.

FIG. 3 illustrates one embodiment of a lithographic offset printing apparatus that may be used with the printing plates described herein.

### DETAILED DESCRIPTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

A lithography printing plate and method for using the same are disclosed. In one embodiment, the printing plate comprises a metallic plate having top and bottom sides with one or more coating layers on the first side of the metallic plate. A layer is attached to the second side of the metallic plate, thereby forming a laminate. By using the laminate layer, less metallic material is needed for the printing plate and the cost of manufacturing the printing plate is reduced.

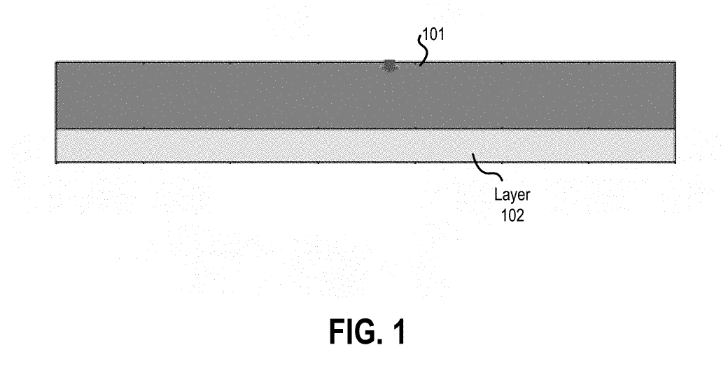

FIG. 1 illustrates an example of a printing plate of the present invention. Referring to FIG. 1, the printing plate includes a metallic layer 101 portion attached to a layer 102 attached to the backside of metallic layer 101. In one embodiment, the top of metallic layer 101 is coated with one or more layer used to create an image on the plate for use in offset printing. These coatings and their application are well-known in the art. Thus, the backside of metallic layer 101 of the printing plate is a non-functioning side with respect to the lithographic printing process. In one embodiment, layer 102 added to the backside of metallic layer 101 of the printing plate comprises a laminate layer. In one embodiment, layer 102 is a clear or colored laminate.

In one embodiment, metallic layer 101 of the printing plate is aluminum. In one embodiment, the printing plate is created by taking an existing printing plate and attaching the laminate layer to its backside. For example, a 12 gage plate may be created by taking an existing 8 gage plate and attaching a 4 gage laminate layer to its backside. In one embodiment, a 12 gage plate may be made with 6 gage aluminum and a 6 gage laminate layer attached to its backside.

In one embodiment, the laminate is added as part of the process for manufacturing the printing plate. For example, in a manufacturing line for creating pre-sensitized printing plates, the line includes initial steps to apply one or more coatings associated with image formation on the top side of a sheet of the metallic layer. After a series of treatments are made with respect to the top side of the metallic layer, but before or after the sheet is cut into individual plates, the laminate is added to the backside of the metallic sheet. In this way, the process of adding a lamination layer to the backside of a printing plate may be integrated into an existing printing plate manufacturing line or an off-line process.

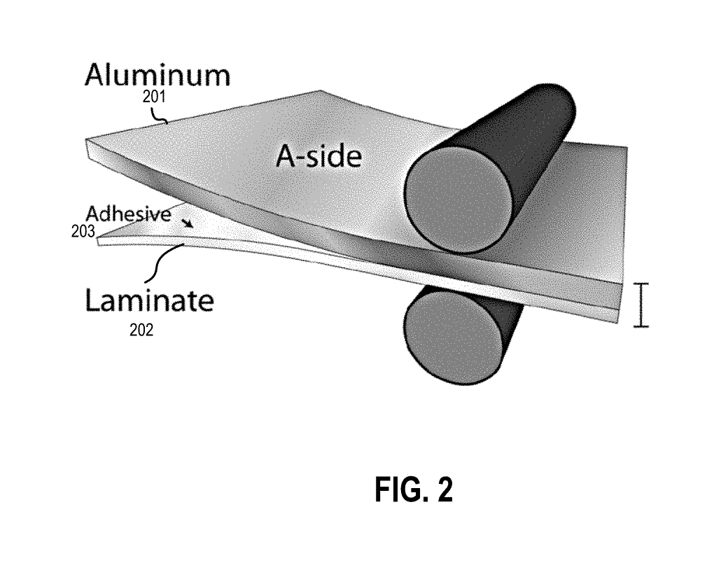

FIG. 2 illustrates another embodiment of a printing plate 200. Referring to FIG. 2, plate 200 includes aluminum layer 201 coupled to laminate 202 via adhesive 203. In on embodiment, aluminum layer 201 is 0.186 mm, laminate layer 202 is 0.089 mm, and the combined width is 0.275 mm. Note that other sized layers may be used. In one embodiment, aluminum layer 201 is pressed against laminate 202 via rollers. However, other techniques for pressing aluminum layer 201 to laminate 202 may be used.

In one embodiment, layer 102 attached to the backside side of the printing plate is a clear or colored plastic film. In one embodiment, the plastic film is one of the following:

Low Density Polyethylene (LDPE);

Linear Low Density Polyethylene (LLDPE);

Linear Medium Density Polyethylene (LMDPE);

High Density Polyethylene (HDPE);

Ethylene Vinyl Alcohol (EVOH);

Ethyl Vinyl Acetate (EVA);

Poly Ethyl Vinyl Acetate (PEVA);

Poly Vinyl Acetate (PVA);

Surlyn (an example of an acid ethylene copolymer);

Polyvinylidene Chloride (PVDC);

Polyvinyl Chloride (PVC);

Polystyrene (PS);

Polyethylene Teraphylate (PET);

Bi-axial Oriented Polyethylene Teraphylate (BoPET);

Polypropylene (PP);

Bi-axial Oriented Polypropylene (BOPP);

Nylon; and

Cellophane (Plastic made from cellulose).

In one embodiment, the clear or colored laminate includes any metalized versions of the polymers listed above. In another embodiment, the clear or colored laminate includes any coextrusions, laminations, and copolymers of the materials listed above. In yet another embodiment, the clear plastic film includes any polyolefins or polyamides not mentioned above. In still another embodiment, the clear plastic film includes any Bi-axial and/or mono oriented for any of the above listed clear plastic films. Note that is doesn't matter that the plastic films are blown or cast and no special coextrusion equipment is needed.

A number of different adhesives may be used to attach the layer to the metallic layer to form the laminated plate. In one embodiment, the adhesive is a water-based acrylic. In another embodiment, the adhesive is a solvent-based acrylic. In yet another embodiment, the adhesive is a solvent-based latex. In alternative embodiments, adhesives include acrylates, cyanoacrylates, epoxies, polyurethanes, and phenolic based adhesives.

In one embodiment, an adhesion promotor is coated onto the either the laminate layer or the backside of the metallic layer to promote the adhesion between the two.

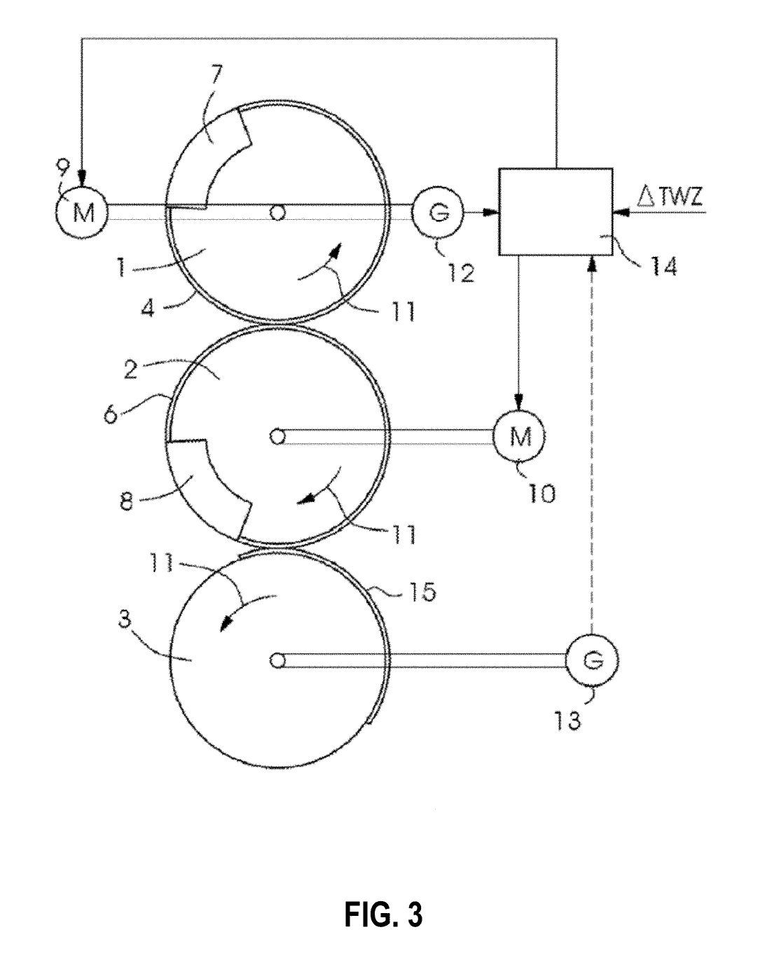

FIG. 3 illustrates one embodiment of a lithographic offset printing apparatus that may be used with the printing plates described above. Referring to FIG. 3, the apparatus comprises a plate cylinder 1, a transfer cylinder 2 and an impression cylinder 3 in a printing unit coupling cylinders 1-3 together in operation. The plate cylinder 1 carries a printing plate, such as the plate described above. The transfer cylinder 2 carries a blanket 6. Each of the cylinders 1, 2 have a respective gap 7, 8 containing clamping devices for the printing plate and the blanket 6. The plate cylinder 1 is directly driven by an electric motor 9. The transfer cylinder 2 and the impression cylinder 3 are driven by a main drive motor 10 through a gear train. During printing, the cylinders 1 to 3 rotate about their axes in the direction of arrows 11. The motors 9, 10 and rotary encoders 12, 13 that register the rotary position of the cylinders 1, 2 are connected to a control unit 14.

In one embodiment, the plates have an image area that is exposed to light which “burns” the image into the plate using a compound that repels water and is receptive to oil, while the rest of the plate is receptive to water and repellent of oil.

The plates are then put on the press where each plate first contacts a roller that coats the non-image area with water, followed by a roller that coats the remainder of the plate (the image area) with ink. The plate is run against a blanket 6 where the image is transferred, or “offset”, onto the blanket 6. Thus, the printing ink on the printing plate is transferred to the surface of the blanket 6. When a sheet 15 passes a nip between the transfer cylinder 2 and the impression cylinder 3 under pressure, the printing ink on the plate is transferred to the surface of the sheet 15 due to the ink splitting effect from the blanket 6. Thus, plates are used to transfer an image onto the blanket 6, and then that image is rolled (offset) onto a sheet of paper.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A lithography printing plate comprising:
metallic plate with one or more coating layers on a first side of the metallic plate;
a layer attached to the second side of the metallic plate.

2. The lithography printing plate defined in claim 1 wherein the layer is a clear or colored laminate layer.

3. The lithography printing plate defined in claim 1 wherein the layer is clear or colored laminate.

4. The lithography printing plate defined in claim 3 wherein the clear or colored laminate layer comprises one or more of:
Low Density Polyethylene (LDPE);
Linear Low Density Polyethylene (LLDPE);
Linear Medium Density Polyethylene (LMDPE);
High Density Polyethylene (HDPE);
Ethylene Vinyl Alcohol (EVOH);
Ethyl Vinyl Acetate (EVA);
Poly Ethyl Vinyl Acetate (PEVA);
Poly Vinyl Acetate (PVA);
Surlyn;
Polyvinylidene Chloride (PVDC);
Polyvinyl Chloride (PVC);
Polystyrene (PS);
Polyethylene Teraphylate (PET);
Bi-axial Oriented Polyethylene Teraphylate (BoPET);
Polypropylene (PP);
Bi-axial Oriented Polypropylene (BOPP);
Nylon; and
Cellophane.

5. The lithography printing plate defined in claim 1 wherein the layer is attached via adhesive.

6. The lithography printing plate defined in claim 5 wherein the adhesive comprises one or more of a water-based acrylic, a solvent-based acrylic, or a solvent-based latex.

7. The lithography printing plate defined in claim 5 wherein the adhesive comprises one or more of acrylates, cyanoacrylates, epoxies, polyurethanes, and phenolic based adhesives.

8. The lithography printing plate defined in claim 1 wherein the metallic plate is aluminum.

9. A lithographic offset printing press comprising:
a rotatable printing plate cylinder containing at least one printing plate; and
a rotatable transfer cylinder with a blanket attached thereto,
wherein the printing plate comprises
metallic plate having a first side and a second side, the first side having one or more coating layers, and
a layer attached to the second side of the metallic plate.

10. The lithographic offset printing press defined in claim 9 wherein the layer is a clear or colored laminate layer.

11. The lithographic offset printing press defined in claim 9 wherein the layer is clear or colored laminate.

12. The lithographic offset printing press defined in claim 11 wherein the clear or colored laminate layer comprises one or more of:
Low Density Polyethylene (LDPE);
Linear Low Density Polyethylene (LLDPE);
Linear Medium Density Polyethylene (LMDPE);
High Density Polyethylene (HDPE);
Ethylene Vinyl Alcohol (EVOH);
Ethyl Vinyl Acetate (EVA);
Poly Ethyl Vinyl Acetate (PEVA);
Poly Vinyl Acetate (PVA);
Surlyn;
Polyvinylidene Chloride (PVDC);
Polyvinyl Chloride (PVC);
Polystyrene (PS);
Polyethylene Teraphylate (PET);
Bi-axial Oriented Polyethylene Teraphylate (BoPET);
Polypropylene (PP);
Bi-axial Oriented Polypropylene (BOPP);
Nylon; and
Cellophane.

13. The lithographic offset printing press defined in claim 9 wherein the layer is attached via adhesive.

14. The lithographic offset printing press defined in claim 13 wherein the adhesive comprises one or more of a water-based acrylic, a solvent-based acrylic, or a solvent-based latex.

15. The lithographic offset printing press defined in claim 13 wherein the adhesive comprises one or more of acrylates, cyanoacrylates, epoxies, polyurethanes, and phenolic based adhesives.

16. The lithographic offset printing press defined in claim 9 wherein the metallic plate is aluminum.
